(19) United States
(12) Patent Application Publication
(10) Pub. No.: US 2016/0140288 A1
(43) Pub. Date: May 19, 2016

(54) METHOD FOR FORMING PERSONAL NUTRITION COMPLEX ACCORDING TO INCIDENCE OF DISEASE AND GENETIC POLYMORPHISM BY A PREDICTION SYSTEM

(71) Applicant: TCI Gene, Inc., Taipei (TW)

(72) Inventors: Shu-Chun Kuan, Taipei (TW); Yung-Hsiang Lin, Taipei (TW); Hui-Hsin Shih, Taipei (TW); Hsueh-Yin Huang, Taipei (TW); Yueh-Ying Tsai, Taipei (TW); Hsing-I Wang, Taipei (TW)

(21) Appl. No.: 14/547,535

(22) Filed: Nov. 19, 2014

(51) Int. Cl. G06F 19/22; G06F 19/00

(52) U.S. Cl. CPC G06F 19/22; G06F 19/3431

(57) ABSTRACT

The present invention relates to a system for predicting an incidence of disease from genetic polymorphism and uses the prediction result to form a personal nutrition complex. The system collects at least one personal information and single nucleotide polymorphism (SNP) information then exchanges the above information with databases including a personal database, a genetic risk database, an allelic frequency database, and a prevalence database. Finally, the system will output a prediction report and indicates a risk of specific disease and a plurality of abnormal genes. According to the prediction results, the system also can provide a plurality of nutritional supplement ingredients to form a personal nutrition complex. Users can receive a comprehensive and an effective nutritional supplement countermeasure about abnormal genes for prevention of the specific disease.

### BACKGROUND OF THE INVENTION

1. Field of the Invention

The present invention relates to a system for predicting an incidence of disease from genetic polymorphism and adopting results thereof to form a personal nutrition complex.

2. Description of the Related Art

According to medical research, many diseases such as hyperglycemia, hyperlipidemia and hypertension, are related to a genetic polymorphism. The genetic polymorphism is normally attributed to genetic variation caused by a nucleotide polymorphism (SNP), meaning that a single nucleotide of a DNA sequence differs between alleles from different genotypes of biological species by substitution, insertion and deletion. As researches on SNP have been widely conducted in the medical field, it is known that a SNP can affect on protein function, gene expression or physiologic reaction, and further affect on incidence of diseases or reactions and metabolic activities of medicine.

The lipoprotein lipase (LPL) gene is related to hypertension, elevated plasma triglyceride and metabolic syndrome. Examination of LPL gene sequence can be used to estimate the risk of suffering from the above diseases of each individual.

In addition, the theory about the interaction between health, diet and genes is provided with the advancement of nutrigenomics. This theory maintains that balance or imbalance of the nutrition of intake will influence health and incidence of disease. According to the above research, many people start to eat nutritional components for the benefit of their health. However, currently the nutritional supplements available on the market are mostly composed by the regular ingredients without providing personalized nutrition complex for each individual. So now if someone needs to take multiple nutrition components, he or she should take a plurality of dosages at the same time, which is very inconvenient.

### SUMMARY OF THE INVENTION

An objective of the present invention is to provide a prediction system for indicating the incidence of the diseases and the abnormal genes for forming a personal nutrition complex. This system alerts subjects for early prevention of disease. Furthermore, the system provides an individual subject with a dietary recipe for a personal nutrition complex specifically designed based on genetic abnormality.

To achieve the foregoing objective, the system for predicting an incidence of a disease by a genetic polymorphism comprises:

a prediction server, the prediction server collecting at least one personal information and at least one genetic information for an information exchange process and a mathematical operation, and producing a prediction report for a user subsequently;

a personal database, the personal database connected with the prediction server for receiving and storing the personal information;

a genetic risk database connected with the prediction server; the genetic risk database including multiple SNP (single nucleotide polymorphism) data and risk data that are correlated with the above genetic information;

an allelic frequency database connected with the prediction server; the allelic frequency database including a plurality of frequency data correlated with the SNP data and the risk data; and

a prevalence database connected with the prediction server; the prevalence database including a plurality of prevalence data for being provided to the server for the mathematical operation to produce the prediction report.

The advantage of the present invention is obtaining a prediction report immediately after testing. The prediction server collects a personal information and a genetic information to pass to the personal database for storage and the genetic risk database for information exchange. According to the genetic information, the SNP data and risk data are obtained from the genetic risk database. And then deliver the above SNP and the risk data to the allelic frequency database to exchange related frequency data and obtain a prevalence data about testing from the prevalence database. After the above exchange information process, the prediction server receives the SNP data, the risk data, the frequency data, and produce a prediction of genetic risk by utilizing the above data for a mathematical operation. Based on the genetic risk and the above prevalence data, the system outputs a prediction report about the testing. It is convenient, quick and efficient to obtain the prediction report about the incidence of the disease and the mutation of the gene. This system can alert subjects for early prevention of disease.

The present invention is to further provide a method for forming a personal nutrition complex according to incidence of disease and genetic polymorphism by a prediction system comprising the steps of:

providing a biological sample taken from a subject;

testing SNP of a plural of genes in said sample and obtaining a result;

utilizing the prediction system to select nutritional supplement ingredients according to the result; and

mixing the above nutritional supplement ingredients and forming a personal nutrition complex.

According to the present invention, the personal nutrition complex consists of a plural of ingredients. The number of ingredient is less than the number of the variation gene. It is effective to reduce frequency, mass and volume of taking nutritional supplement ingredients for the subjects.

Northern blotting or Southern blotting is utilized to test SNPs of the allelic genotype for different subjects or cells. The principle is using a labeled nucleotide probe to hybridize with a filter membrane which comprises a target RNA or a DNA separated by electrophoresis and transferred to the filter membrane. By this way, the target RNA or the DNA can be detected by the labeled nucleotide probe. Besides, examination of SNPs can also be conducted by amplifying a sequence of a specific region of a target gene by a polymerase chain reaction (PCR) and then double checking the sequence accuracy by a DNA sequencing. Other skills about analyzing the sequence of SNPs sites such as, but not limited to, a Ligase Chain Reaction (LCR), also can assist with a SNP genotyping.

In order to discriminate SNPs of the sample, two labeled nucleotide probes that are designed to have a SNP site of a specific gene can be utilized to test the sample. We can determine the SNP of the specific gene in the sample by observing whether a labeled nucleotide sample is binding with the two labeled nucleotide probes or not. This method is utilizing the principle that two complementary nucleotides can bind together. Above of the two labeled nucleotide probes only contain a difference in a single nucleotide.

Preferably, the plural of genes include a adipogenesis-related gene, a appetite control gene, a metabolism gene and a endocrine regulation gene.

Preferably, by inputting a genetic testing result of the SNPs into the prediction system, incidence of a specific disease and an abnormal gene can be obtained. Then the prediction system will select a nutritional supplement ingredient that is related to the abnormal gene and form a personal nutrition complex. When the genetic testing result indicates that the subject is susceptible to ectopic fat deposition and the adipogenesis-related gene is abnormal, the system will select first nutritional supplement ingredients to form a personal nutrition complex. When the result indicates that the subject is susceptible to loss of appetite control and the appetite control gene is abnormal, the system will select second nutritional supplement ingredients to form a personal nutrition complex. When the result indicates that the subject is susceptible to metabolic disorder and the metabolism gene is abnormal, the system will select third nutritional supplement ingredients to form a personal nutrition complex. When the result demonstrates that the subject is susceptible to endocrine dysregulation and the endocrine regulation gene is abnormal, the system will select fourth nutritional supplement ingredients to form a personal nutrition complex.

According to the present invention, the first, second, third, and fourth nutritional supplement ingredients include plant extracts and synthetic compounds. The plant extracts and the synthetic compounds are commonly known to be related to the plural genes of testing.

The adipogenesis-related gene is related to the fat deposition and the differentiation of the fat cell. The adipogenesis-related gene includes, but is not limited to, peroxisome proliferator-activated receptor gamma 2 (PPARG2). The PPARG2 mainly involves in preadipocyte to adipocyte differentiation. At the initial phase of adipocyte differentiation, C/EBPβ and C/EBPδ are induced first, and stimulated expression of downstream genes, C/EBPα and PPARγ2. The C/EBPβ and C/EBPδ genes play important roles in adipocyte differentiation and they can interact with each other. When PPARG2 is activated, the downstream genes will be expressed, and increased production of fat cells. A guanine nucleotide binding protein beta-subunit 3 (GNB3) gene is in charge of producing Beta-3 subunit of a G-protein. The G-protein belongs to a signal transduction protein on a cell membrane. It is involved in transmitting signals from a variety of different pathway outside the cell into nucleus. The transmitting signals include MAPK signaling pathway in adipocyte differentiation.

The appetite control gene is related to controlling the sense of satisfaction, stress relaxation and appetite, including, but not limited to, syndecan 3 (SDC3). SDC3 is a transmembrane protein. Expression of the SDC3 is upregulated in the brain hypothalamus of the feeding center when fasting. The SDC3 will bind with AGRP and MC4R and form a complex, so that the appetite of the subject will be raised. Leptin (LEP) can maintain the body fat percentage by controlling the appetite and increase consumption of the energy. Melanocortin 4 receptor (MC4R) is related to the appetite and an energy exhaustion in a brain. The MC4Rregulates function of food intake. MC4R defects can lead to overweight and chronic hyperingestion.

The metabolism gene is related to metabolism of carbohydrate and lipids, including, but not limited to, uncoupling protein 3 (UCP3). The UCP3 facilitates to transfer anions from an inner member to an outer membrane and reduce the mitochondrial membrane potential. The UCP3 gene is primarily expressed in a skeletal muscle. Gene expression level of UCP3 is increased with intake of fatty acid and glucose, and the body will produce more energy. The other gene is beta-2-adrenergic receptor (ADRB2). The ADRB2 is related to a fight-or-flight response. People will reduce response of epinephrine if the ADRB2 gene is mutated. The ADRB2 gene also can decrease the efficiency of glucose metabolism and affect contractility of skeletal muscle and cardiac muscle. Peroxisome proliferator-activated receptor-gamma coactivator 1, beta (PPARGC1B) can regulate transcription factors and nuclear receptors. The nuclear receptors include estrogen receptors and glucocorticoid receptors that can affect metabolism of lipids, anaerobic glycolysis and energy expenditure. Fat mass and obesity associated gene (FTO) can inhibit a metabolic rate and lead to slow motion. It also can inhibit metabolic energy converted into heat within the body. The FTO deficient mice increase in basal metabolic rate compared with normal mice.

The endocrine regulation gene is related to endocrine regulation and directly or indirectly affects energy expenditure and body fat distribution, including, but not limited to, peroxisome proliferator-activated receptor-gamma (PPARG). The structure of PPARG is similar to the steroid and thyroid hormone receptor superfamily, called peroxisome proliferators-activated receptor because PPARG can be switched on by a peroxisome proliferating agents such as cloridrate, Nafenopin and WY14643. Estrogen receptor 1 (ESR1) can mediate membrane-initiated estrogen signaling and indirectly influence energy expenditure and body fat distribution. Nuclear receptor subfamily 0, group B, member 2 (NR0B2) is primarily expressed in the liver and used to balance cholesterol and control the transcriptional activity for secretion of insulin in the pancreas cell. If the NR0B2 is inactivated, the subject will be overweight.

In the present invention, the first nutritional supplement ingredients can break down fat quickly and therefore avoid fat accumulation. The first nutritional supplement ingredients includes, but not limited to, bitter orange (Citrus aurantium) flavonoids or roselle extracts. The second nutritional supplement ingredients can control satiety, food intake and stress release. The second nutritional supplement ingredients include, but not limited to, banana peel extracts, vitamin B6, or vitamin B12. The third nutritional supplement ingredients can improve the body's efficiency in using macronutrients (fat, carboxyhydrate and protein). The third nutritional supplement ingredients include, but not limited to lotus leave extracts, white kidney bean extracts, fermented vegetable and fruit, and tea flower (Camellia sinensis) extracts. The fourth nutritional supplement ingredients can stimulate or suppress hormone secretions. The fourth nutritional supplement ingredients include, but not limited to, cranberry extracts or green tea extracts.

Compared to a normal allelic genotype, an abnormality indicates an allelic variant in the present invention. For example, functional variations of proteins or enzymes caused by the SNPs will lead to physiological changes followed by enhancing risk of suffering specific disease. If the SNP site in rs1822825 (G/A) of the PPARG is A, but not G, this result demonstrates that the PPARG gene is the genetic variation. When SNP sites of two alleles are both A, the body is more prone to obesity than when the SNP site of at least one allele is G.

According to the prediction system and method, the subject can receive a prediction result of disease and a plurality of abnormal genes by SNP genotyping. The system further can select a plurality of nutritional supplement ingredients corresponding to the abnormal genes, but not just provide only one nutritional supplement ingredient from a single gene. So the subject can receive a comprehensive and effective nutritional supplement countermeasure according to the plurality of abnormal genes by the prediction system.

Furthermore, the present method can mix the plurality of nutritional supplement ingredients to form a complex corresponding to the abnormal genes that are selected from the prediction system. The present method has advantages over the prior arts that disperse many nutritional supplement ingredients to multiple tablets. This method can effectively control volume and number of tablets and also provides a personal nutritional complex for each individual and draft a standard dosage. The present method can encourage people to take nutritional supplement complex and reduce numbers of tablets and mistakes of frequency.

### BRIEF DESCRIPTION OF THE DRAWINGS

FIG. 1 is a block diagram of the prediction system for incidence of disease by genetic polymorphism in accordance with the present invention;

FIG. 2 is an application mode diagram of the prediction system for incidence of disease by genetic polymorphism in accordance with the present invention;

FIG. 3 is a statistics curve chart for prediction report of the prediction system for incidence of disease by genetic polymorphism in accordance with the present invention;

FIG. 4 is another application mode diagram of the prediction system for incidence of disease by genetic polymorphism in accordance with the present invention;

FIG. 5 is another statistics curve chart for prediction report of the prediction system for incidence of disease by genetic polymorphism in accordance with the present invention;

FIG. 6 is still another application mode diagram of the prediction system for incidence of disease by genetic polymorphism in accordance with the present invention;

FIG. 7 is still another statistics curve chart for prediction report of the prediction system for incidence of disease by genetic polymorphism in accordance with the present invention; and

### DETAILED DESCRIPTION OF THE INVENTION

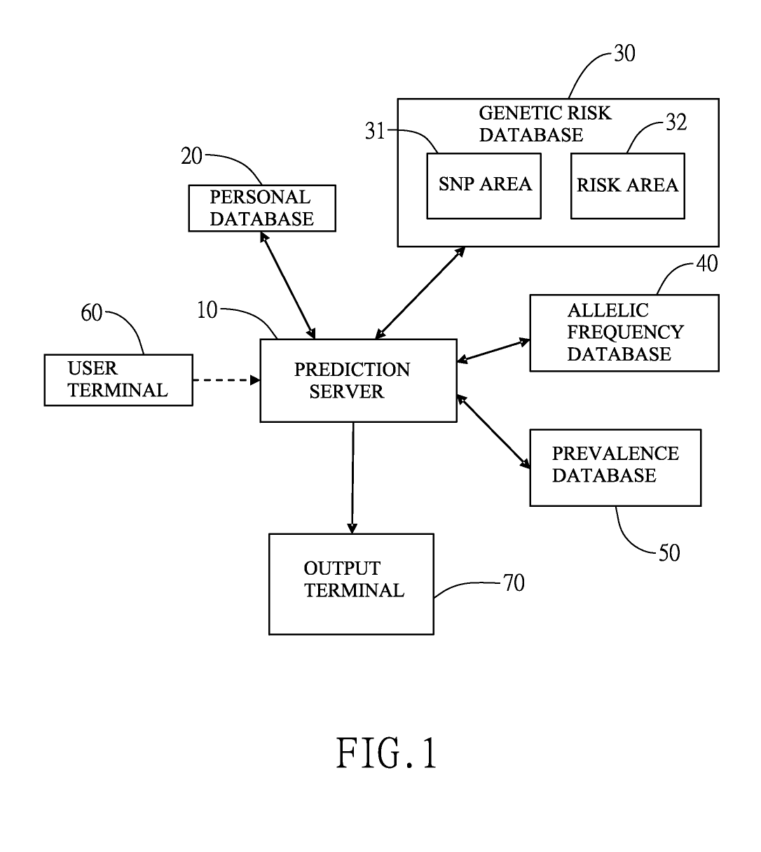

With reference to FIG. 1, the prediction system for incidence of disease by genetic polymorphism comprises a prediction server 10, a personal database 20, a genetic risk database 30, an allelic frequency database 40, and a prevalence database 50.

The prediction server 10 is connected with at least one user terminal 60. The prediction server 10 is also connected with the personal database 20, the genetic risk database 30, the allelic frequency database 40, and the prevalence database 50. A user can input at least one personal information and at least one genetic information to the user terminal 60 and then the prediction server 10 will exchange information to the personal database 20. After information exchange process, the prediction system will go on a mathematical operation and then produces a prediction report. By this way, user can receive the prediction report from a report output terminal 70 shortly.

The personal database 20 is used to receive the personal information from the prediction server 10 and store the received personal information. The personal database 20 also can provide saved personal information for the prediction server 10 to read at any time.

The genetic risk database 30 is used to receive a genetic information from the prediction server 10. The genetic risk database 30 has many SNP data and risk data corresponding to the genetic information. According to the genetic information, the prediction server 10 exchanges information with the genetic risk database 30 and obtains a corresponding SNP data and risk data.

In one embodiment, the genetic risk database 30 further includes a SNP area 31 and a risk area 32. The SNP area 31 is used to store and read the SNP data. The SNP data includes a plurality of genotypes. Each genotype is composed of a pair of alleles, one from the father, and the other from mother. For example, when the alleles are G and A in the SNP data, the genotype may comprise three forms of GG, GA or AA.

The risk area 32 is used to store and read the risk data. The risk data is an Odds Ratio (OR) data. The OR data is calculated from the odds by two things. In one embodiment, the OR data implies the genetic or allelic risk of disease.

The allelic frequency database 40 is used to receive and store the SNP data and the risk data from the prediction server 10. The allelic frequency database 40 has a plurality of frequency data corresponding to the SNP data and risk data. The prediction server 10 obtains a frequency data after exchanging data with the allelic frequency database 40. In one embodiment, the frequency data is an allelic data of frequency, which is a ratio between alleles and genotypes in a group. For example, the frequency is 0.5 when three among six people have GG genotype. The frequency is 0.333 when two among six people have GA genotype. The frequency is 0.167 if only one among six people has AA genotype. When the number of allele is twelve, for eight of twelve alleles being G, the allelic frequency is 0.667. For four of the twelve alleles being A, the allelic frequency is 0.333.

The prevalence database 50 has a multiple prevalence data. The prediction server 10 obtains a prevalence data that is related to the test subject from the prevalence database 50. After the prediction server 10 obtains the SNP data, the risk data and the frequency data by data exchange process and calculate a plural of relative risks (RR), the prediction system can output a genetic risk. The prediction system also can output a prediction report quickly about the test subject according to the relative risk and the prevalence data.

In one embodiment, the genetic risk database 30, the allelic frequency database 40 and the prevalence database 50 are external databases. The prediction server 10 connects to the external databases and obtains the latest SNP data, risk data, frequency data and prevalence data from the external databases at any time.

In one embodiment, the prediction server 10 collects a personal information and a genetic information related to the test subject through the user terminal 60. The prediction server 10 passes the above information to the personal database 20 and the genetic risk database 30 to exchange information. According to the genetic information, the prediction system can obtain SNP data and OR data from the genetic risk database 30. Subsequently, the prediction system passes the SNP data and the OR data to the allelic frequency database 40 to exchange data. Then the prediction system can further obtain a corresponding frequency data. Through the prevalence database 50, the user can obtain a prevalence data about the test subject.

When the prediction server 10 obtains the SNP data, the OR data and the frequency data by the above information exchange process and calculates the relative risk (RR), the prediction server 10 further produces a genetic risk by the relative risk (RR). Through calculating the genetic risk and the above prevalence data, user can quickly get a prediction report for every physiological stage. User can use this convenient, fast and efficient method to receive a reference about incidence of disease for their genes for early prevention of diseases.

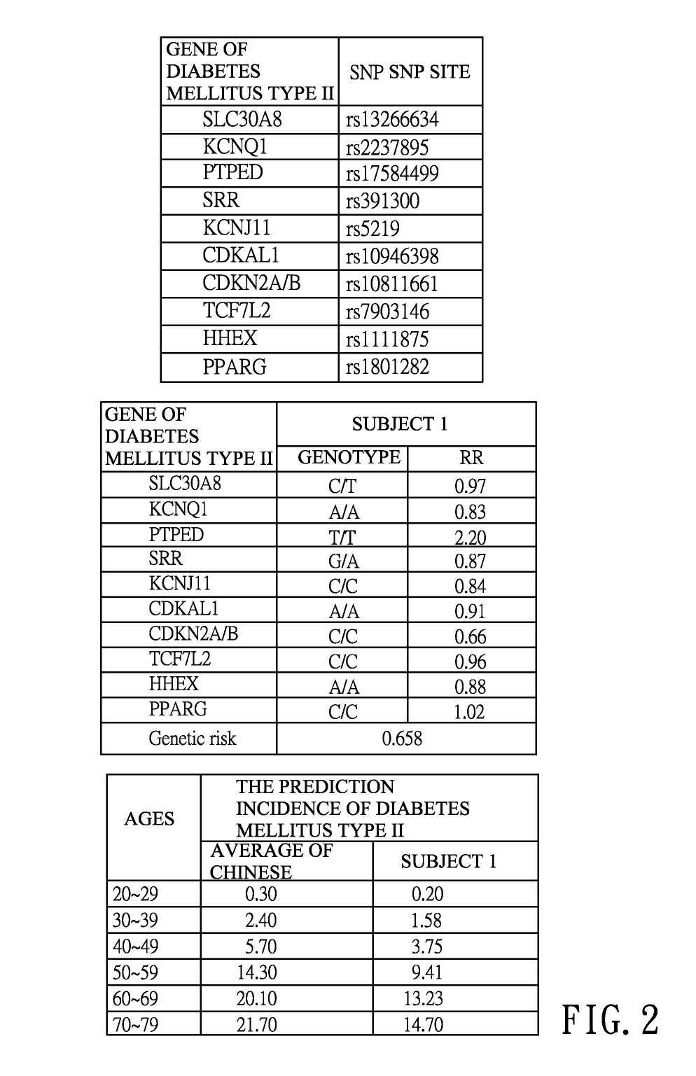

With reference to FIG. 2, a human subject had been tested for diabetes mellitus type II in a hospital. The hospital can obtain a personal information (citizenship, age and credentials) and a genetic information. The human subject or medical staff can connect the prediction server 10 and the user terminal 60. Then the human subject or medical staff can use a credential to sign in the prediction system. Finally, the human subject or medical staff can obtain a prediction report from the report output terminal 70. The prediction report includes the following information.

The SNP data related to Diabetes mellitus type II comprises multiple genes and the SNP sites of the multiple genes which includes the rs13266634 of SLC30A8 gene, the rs2237895 of KCNQ1 gene, the rs17584499 of PTPRD gene, the rs391300 of SRR gene, the rs5219 of KCNJ11 gene, the rs10946398 of CDKAL1 gene, the rs10811661 of CDKN2A/B gene, the rs7903146 of TCF7L2 gene, the rs1111875 of HHEX gene and the rs1801282 of PPARG gene. The SNP data is corresponding to a plurality of gene data (genotype) and relative risk (RR). It further provides the genetic risk to the subject.

The prevalence database 50 provides a plurality of prevalence data. For an average of incidence of Chinese, the prevalence data is related to Diabetes mellitus type II of all ages. The prediction incidence of Diabetes mellitus type II is produced by the prevalence data and the genetic risk of all ages for subjects.

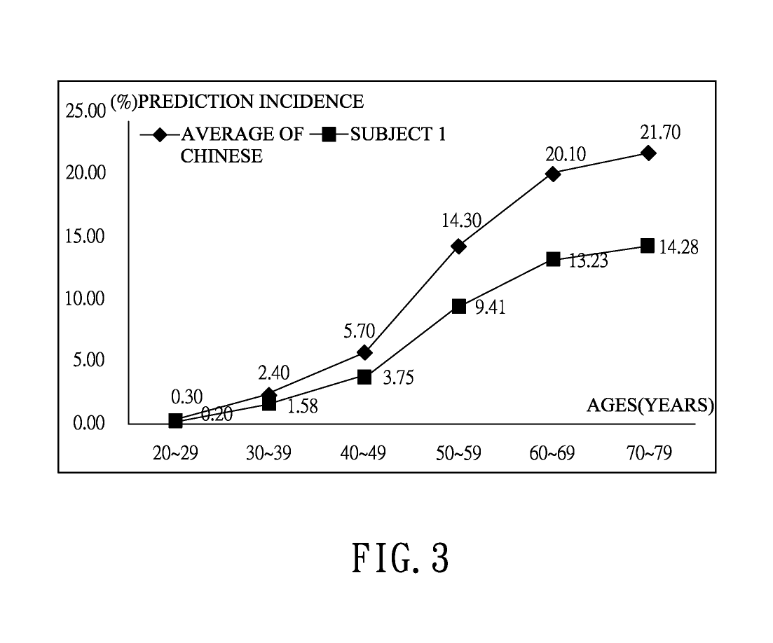

With reference to FIG. 3, the curve chart is an analysis result of an incidence of Diabetes mellitus type II. The horizontal axis represents ages, and the vertical axis represents percentage of incidence. The age in horizontal axis is from 20 to 79 with each stage being ten years. When Chinese' percentage of incidence from aged 40 to 59 years old rises from 5.7% to 14.3%, the human subject's percentage of incidence rises from 3.75% to 9.41%, which is lower than the average of incidence of Chinese, showing that the human subject is healthier. However, the human subject also has a similar rising trend from aged 40 to 59 years old with the rising trend of the Chinese. So the human subject has to take care about his diet and lifestyle to prevent Diabetes mellitus type II.

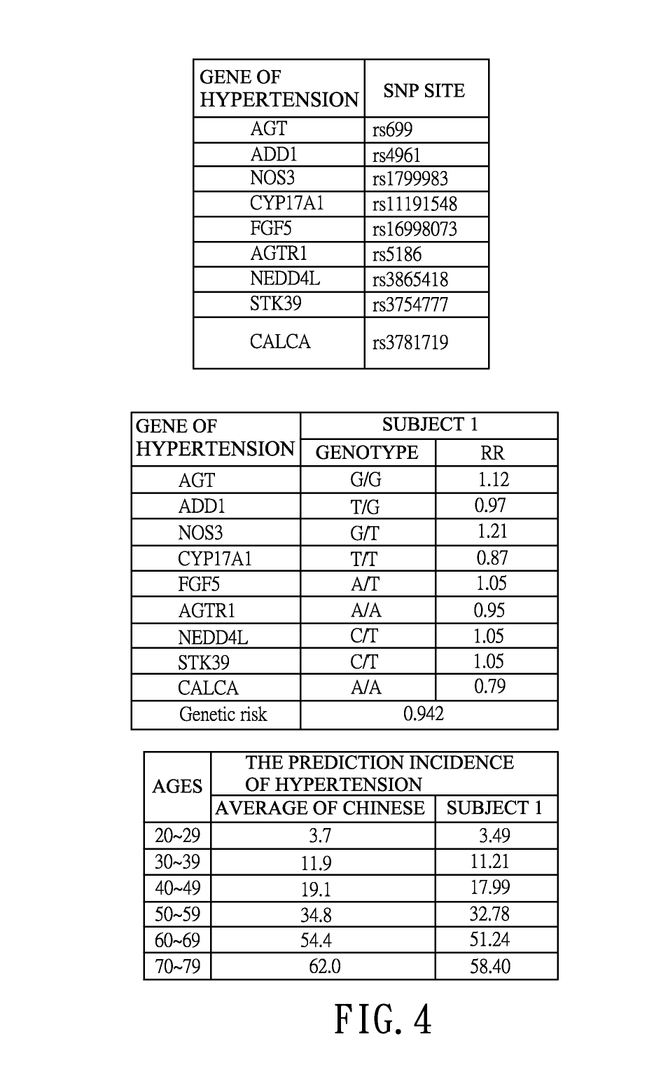

With reference to FIG. 4, one Chinese subject had been tested for hypertension in a hospital. The subject or medical staff can obtain a prediction report from the report output terminal 70. The prediction report included the following information:

The SNP data related to hypertension comprises multiple genes and the SNP sites of the multiple genes which includes the rs699 of AGT gene, the rs4961 of ADD1 gene, the rs1799983 of NOS3 gene, the rs11191548 of CYP17A1 gene, the rs16998073 of FGF5 gene, the rs5186 of AGTR1 gene, the rs3865418 of NEDD4L gene, the rs3754777 of STK39 gene and the rs3781719 of CALCA gene. Each gene is corresponding to the plurality of gene data (genotype) and relative risk (RR) for the subject. It also provides a genetic risk to the subject. The prevalence database 50 provides a plurality of prevalence data. For an average of incidence of Chinese, the prevalence data is relate to hypertension of all ages. The prediction incidence of hypertension is produced by the prevalence data and the genetic risk of all ages for subject.

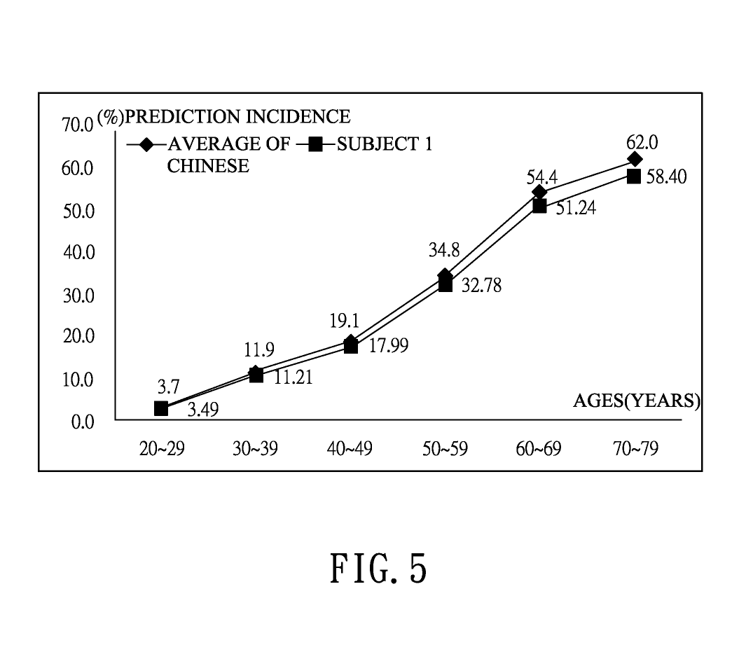

With reference to FIG. 5, the curve chart is an analysis result about incidence of hypertension. The horizontal axis represents ages, and the vertical axis represents percentage of incidence. The age in horizontal axis is from 20 to 79 and each stage is ten years old. When the Chinese' percentage of incidence from aged 20 to 39 years old rises from 3.7% to 11.9%, the subject's percentage of incidence rises from 3.49% to 11.21%. The percentage of incidence the subject is identical to percentage of incidence of the Chinese when his age is from 20 to 39. Even when the subject's age is from 70 to 79, the percentage of incidence is similar to the Chinese. So the subject has to take care about his diet and lifestyle more carefully to prevent the hypertension.

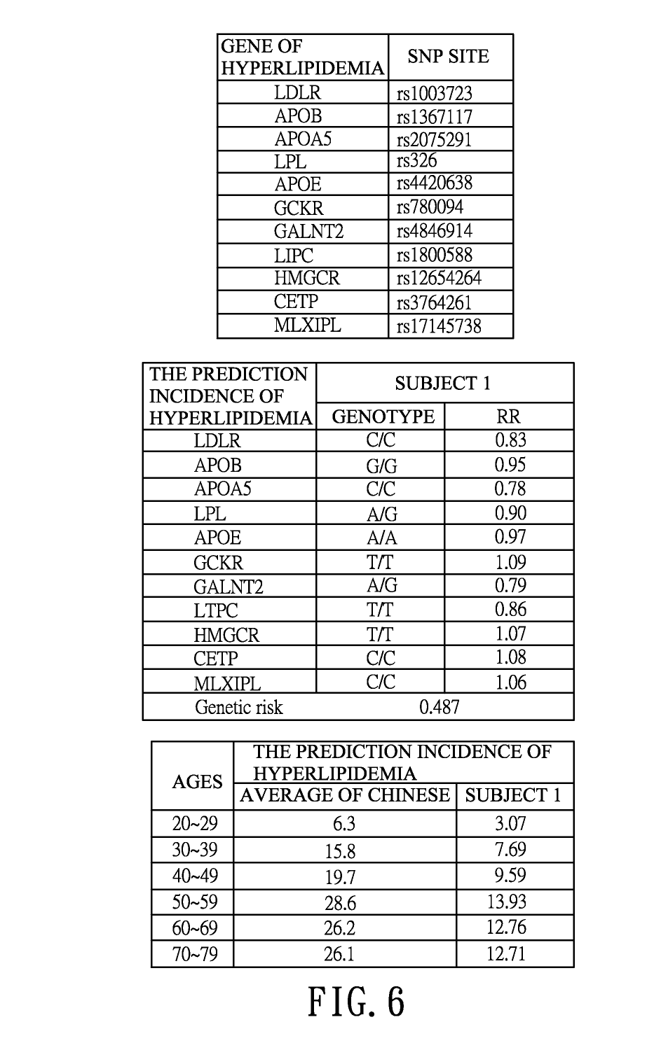

FIG. 6, this is another application mode identical to the above embodiments. The only difference is the test subject. The test subject is related to hyperlipidemia. The human subject or medical staff can obtain a prediction report from the report output terminal 70. The prediction report includes the following information.

The SNP data related to hyperlipidemia comprises multiple genes and the SNP sites of the multiple genes which includes the rs1003723 of LDLR gene, the rs1367117 of APOB gene, the rs2075291 of APOA5 gene, the rs326 of LPL gene, the rs4420638 of APOE gene, the rs780094 of GCKR gene, the rs4846914 of GALNT2 gene, the rs1800588 of LIPC gene, the rs12654264 of HMGCR, the rs3764261 of CETP gene, and the rs17145738 of MLXIPL gene. These genes are related to the plurality of gene data (genotype) and relative risk (RR) for the test subject. They also provide a genetic risk to the test subject. The prevalence database 50 provides a plurality of prevalence data. For an average of incidence of Chinese, the prevalence data is related to hyperlipidemia of all ages. The prediction incidence of hyperlipidemia is produced by the prevalence data and the genetic risk of all ages for the subject.

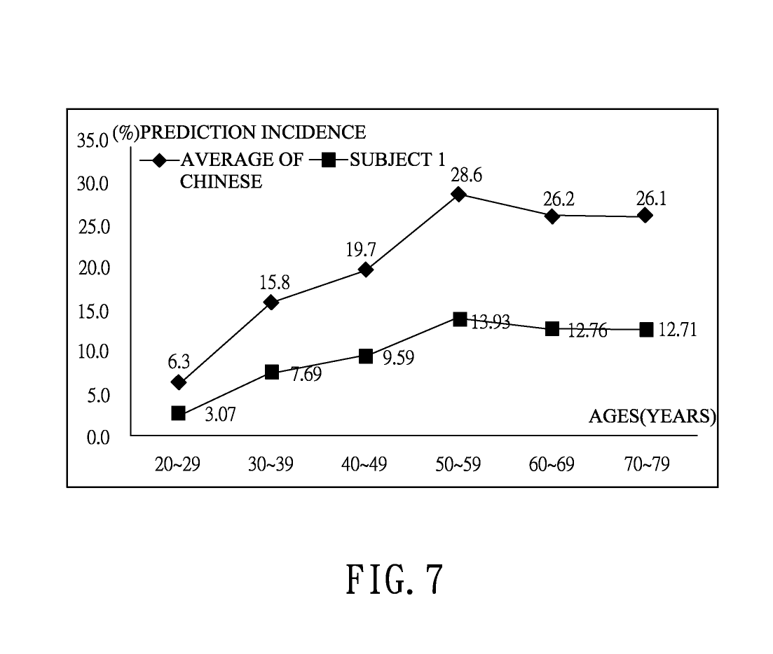

With reference to FIG. 7, the curve chart is an analysis result related to incidence of hyperlipidemia. The horizontal axis represent ages, and the vertical axis represents percentage of incidence. The age in horizontal axis is from 20 to 79 and each stage is ten years old. When the Chinese' percentage of incidence from aged 40 to 59 years old rises from 19.7% to 28.6%, the human subject's percentage of incidence rises from 9.59% to 13.93%. So the percentage of incidence of the human subject is lower than the percentage of incidence of the Chinese, indicating that the human subject is healthier. However, the human subject also has to take care about his lifestyle.

From the foregoing, the prediction system of the present invention for incidence of disease by genetic polymorphism mainly collects personal information and genetic information by the prediction server 10. The prediction server 10 transfers the personal information to the personal database 20 for storage, and exchange the personal information with the genetic risk database 30. According to the SNP data and the risk data, the prediction system transfers the above SNP data and risk data to the allelic frequency database 40 to exchange a relative frequency information and obtain a prevalence information from the prevalence database 50. After the above exchange process, the prediction server 10 receives a SNP data, a risk data, a frequency data, and produces a genetic risk by above data. Based on the genetic risk and the above prevalence information, the system outputs a prediction report. It is a convenient, quick and efficient method to obtain a prediction report about the incidence of the disease and the mutation of the gene. This system can alert subjects for early prevention of disease.

This invention uses known SNPs of genes to recognize the specific SNP site and genotype of adipogenesis-related gene, appetite control gene, metabolism gene and endocrine regulation gene by the biological sample from human subject. The prediction system of an incidence of disease will determine an incidence of disease and an abnormal gene by entering the genotype to the system. It means human subject is susceptible to specific disease. Then the system will select nutritional supplement ingredients according to the abnormal gene and mix the ingredients with a carrier to form a nutritional complex tablet. In the following embodiments, the system determines more than 500 genotypes that have middle and high risk to suffer disease. According to the embodiments, a personal nutrition complex can be formed in advance to fight disease. Furthermore, the system can provide many kinds of compositions to complete the prevention for different human subjects.

In a preferred embodiment, the gene of adipogenesis is peroxisome proliferator-activated receptor gamma 2 (PPARG2) or guanine nucleotide binding protein beta-subunit 3 (GNB3).

In a preferred embodiment, the gene of appetite control is syndecan 3 (SDC3), leptin (LEP) or melanocortin 4 receptor (MC4R).

In a preferred embodiment, the SNP sites of genes include PPARG-rs1822825 (G/A), PPARGC1B-rs7732671 (G/C), PPARG2-rs1801282 (C/G), GNB3-rs5443 (C/T), LEP-rs104894023 (C/T), SDC3-rs2282440 (C/T), MC4R-rs121913561(A/G), UCP3-rs17848368 (C/T), ADRB2-rs1042714 (C/G), NR0B2-rs74315350 (G/T), APOE-rs429358 (T/C), GHRL-rs696217 (C/A), FTO-rs6499640 (A/G), ESR1-rs712221 (A/T) and AGT-rs699 (T/C). Persons having ordinary skills in the art can choose proper SNP sites according to the corresponding strategy and four gene types.

In a preferred embodiment, the SNP sites of gene are the rs1801282 of PPARG2 gene, the rs5443 of GNB3 gene, the rs2282440 of SDC3 gene, the rs104894023 of LEP gene, the rs121913561 of MC4R gene, the rs17848368 of UCP3 gene, the rs1042714 of ADRB2 gene, the rs7732671 of PPARGC1B gene, the rs6499640 of FTO gene, the rs1822825 of PPARG gene, the rs74315350 of NR0B2 gene and the rs712221 of ESR1 gene.

In a preferred embodiment, the first nutritional supplement ingredient is bitter orange (Citrus aurantium) flavonoids or roselle extracts.

In a preferred embodiment, the second nutritional supplement ingredient is banana peels extracts, vitamin B6 or vitamin B12.

In a preferred embodiment, the third nutritional supplement ingredient is lotus leave extracts, white kidney bean extracts, fermented vegetable and fruit, or tea flower (Camellia sinensis) extracts.

In a preferred embodiment, the fourth nutritional supplement ingredient is cranberry extracts or green tea extracts.

According to the present invention, the extract is crushed and grinded from the material and then mixed with an aqueous solvent or a non-polar reagent. Then the extract is produced by a freeze-dried step after filtering. For example, the lotus leave extracts is dried, crushed and grinded from the lotus then mix with the aqueous solvent. Finally the powder of lotus leave extracts is produced by freeze-dried step after filtering.

In a preferred embodiment, the carrier includes, but is not limited to, excipients, diluents, disintegrants, glidants, binders, lubricants, anti-adhesion agent and/or glidants. Furthermore, sweeteners, flavors, coloring agents and/or coating can be added to achieve a specific purpose.

In a preferred embodiment, the number of carrier is in accordance with oral dose. The oral dose means user does not have difficulty swallowing that is declared in the pharmacopoeia clearly. The solid reagent is a pastille, a tablet or a capsule. The diameter of the solid reagent is less than 1.5 cm. The weight of solid reagent is less than 1.5 g. The number of solid reagent is less than 15, preferably 12, more preferably is 10 to 5, and further more preferably is 1. Specifically, the solid reagent is a spherical pastille and the weight of each spherical pastille is 0.7 g. The solid reagent is a powder or a granules. The total weight of the solid reagent is less than 20 g, preferably 10 g, and more preferably is 8.4 g.

Even though numerous characteristics and advantages of the present invention have been set forth in the following description, together with details of the field and technology of the invention, the disclosure is illustrative only. Do not limit present invention of the scope.

### EMBODIMENT

A DNA sample was obtained from a volunteer. The genotype of SNP was determined by TaqMan (TaqMan® SNP Genotyping Assays, purchased from Applied Biosystems Inc.). The assays utilized two probes of wild-type and mutant-type in accordance with SNP to hybridize specifically to the differentiated allele. The probe 5′ is labeled with different fluorescents, which are called reporter dye. The reporter dye usually is a FAM™ dye and a VIC™ dye and can also be replaced with other dyes such as a TET dye. Then probe 3′ is labeled with a fluorescent absorber, which is called a quencher dye, and is a non-fluorescent. The fluorescent absorber usually is tetramethylrhodamine (TAMRA). When the two probes has not yet hybridized with DNA templates, the quencher dye on the probe 3′ can absorb energy of the fluorescent from the reporter dye on the probe 5′. With this mechanism, the fluorescent dye can't release fluorescent until polymerase chain reaction (PCR) is started. The DNA polymerase with 5′exonuclease function will cut off probes that are attached to the DNA template. Then the reporter dye and the quencher dye are separated from the probes. Finally, the fluorescent dye on the probe 5′ is excited and releases fluorescence which can be detected by a fluorescent reader. The analysis for SNP of PPARG, PPARG2, PPARGC1B, GNB3, LEP, SDC3, MC4R, UCP3, ADRB2, NR0B2, FTO and ESR1 is achieved by using TaqMan Assays.

The SNP sites of genes are the rs1801282 of PPARG2 gene, the rs5443 of GNB3 gene, the rs104894023 of LEP gene, the rs2282440 of SDC3 gene, the rs121913561 of MC4R gene, the rs17848368 of UCP3 gene, the rs1042714 of ADRB2 gene, the rs6499640 of FTO gene, the rs74315350 of NR0B2 gene, the rs1822825 of PPARG gene and the rs712221 of ESR1 gene.

Table 1 shows analysis results of allele and nucleotide sequence for the above SNP sites:

TABLE 1

| Gene | Low risk | Middle risk | High risk |
|---|---|---|---|
| PPARG2 | C/C | C/G | G/G |
| GNB3 | C/C | C/T | T/T |
| LEP | C/C | C/T | T/T |
| SDC3 | C/C | C/T | T/T |
| MC4R | A/A | A/G | G/G |
| UCP3 | T/T | T/C | C/C |
| ADRB2 | C/C | C/G | G/G |
| PPARGC1B | G/G | G/C | C/C |
| FTO | G/G | G/A | A/A |
| NR0B2 | G/G | G/T | T/T |
| PPARG | G/G | G/A | A/A |
| ESR1 | A/A | A/T | T/T |

When the above genotype of gene belongs to the middle risk and high risk groups, the prediction system will determine that the gene is an abnormal gene. The prediction system selects nutritional supplement ingredients in accordance with the abnormal genes by discriminating genotype of SNP sites for PPARG2, GNB3, LEP, SDC3, MC4R, UCP3, ADRB2, PPARGC1B, FTO, NR0B2, ESR1, and PPARG gene. If PPARG2 and GNB3 are abnormal genes, the system will choose bitter orange (Citrus aurantium) flavonoids and roselle extracts to form a complex. If SDC3 is an abnormal gene, the system will choose banana peels extracts, vitamin B6 and vitamin B12 to form a complex. If UCP3, ADRB2, PPARGC1B and FTO are abnormal genes, the system will choose lotus leave extracts, white kidney bean extracts, fermented vegetable & fruit and tea flower (Camellia sinensis) extracts to form a complex. If ESR1 and PPARG are abnormal genes, the system will choose cranberry extracts and green tea extracts to form a complex.

Table 2 shows nutritional supplement ingredients correlated with the genes as follows:

TABLE 2

| | | Ingredients of | | | | | | | |
|---|---|---|---|---|---|---|---|---|---|
| Cate- | | Nutritional | Embodiment | | | | | | |
| gory | Gene | Supplement | 1 | 2 | 3 | 4 | 5 | 6 | 7 |
| 1 | PPARG2 | Bitter Orange | | | | | | | |
| | | Flavonoids | | | | | | | |
| | | (400 mg) | | | | | | | |
| | GNB3 | Roselle | V | V | V | V | V | V | V |
| | | Extracts | | | | | | | |
| | | (350 mg) | | | | | | | |
| 2 | SDC3 | Banana Peels | V | V | V | V | V | V | V |
| | | Extracts | | | | | | | |
| | | (100 mg) | | | | | | | |
| | | Vitamin B6 | | | | | | | |
| | | (1.5 mg) | | | | | | | |
| | | Vitamin B12 | | | | | | | |
| | | (2.4 μg) | | | | | | | |
| 3 | UCP3 | Lotus leave | | V | V | V | | | |
| | | Extracts | | | | | | | |
| | | (1.2 g) | | | | | | | |
| | ADRB2 | White Kidney | V | | V | V | | V | V |
| | | Bean Extracts | | | | | | | |
| | | (1.2 g) | | | | | | | |
| | PPARGC1B | Fermented | V | V | | V | V | | V |
| | | Vegetable & | | | | | | | |
| | | Fruit | | | | | | | |
| | | (500 mg) | | | | | | | |
| | FTO | tea flower | V | V | V | | V | V | |
| | | (Camellia | | | | | | | |
| | | sinensis) | | | | | | | |
| | | Extracts | | | | | | | |
| | | (200 mg) | | | | | | | |
| 4 | ESR1 | Cranberry | V | V | V | V | V | V | V |
| | | Extracts | | | | | | | |
| | | (100 mg) | | | | | | | |
| | PPARG | Green Tea | V | V | V | V | V | V | V |
| | | Extracts | | | | | | | |
| | | (450 mg) | | | | | | | |
| — | — | Add carrier | | | | | | | |
| | | to 8.4 g | | | | | | | |

The “V” symbol is employed here to indicate the use of nutritional supplements or carriers for those identified to have been related to the abnormal gene having middle or high risk genotype. Then related nutritional supplement ingredients and carriers are selected to form the personal nutrition supplement.

According to the test result, the prediction system will select and mix related nutritional supplement ingredients when the SNP sites of GNB3-rs5443, SDC3-rs2282440, ADRB2-rs1042714, PPARGC1B-rs7732671, FTO-rs6499640, ESR1-rs712221, PPARG-rs1822825 are in the high risk. The nutritional supplement ingredients include roselle extracts (40% roselle calyx extract powder, COMPSON TRADING CO., LTD), banana peels extracts (50 mg/g Serontoinic freeze-dried powder, TCI Firstek CORP.), vitamin B6 or vitamin B12, white kidney bean extracts (10000 unit/g PHY, TCI Firstek CORP.), fermented vegetable & fruit (TCI CO., LTD), tea flower (Camellia sinensis) extracts (Japanese HARIMA, Mitsubo Co., LTD), cranberry extracts (COMPSON TRADING CO., LTD) and green tea extracts (90% polyphenols IND/EGCG 46.4%, TCI Firstek CORP.). The extracts are crushed and grinded from the material and then mixed with an aqueous solvent or a non-polar reagent. Then the extracts are produced by a freeze-dried step after filtering. Then the personal nutrition complex in the embodiment 1 is made by a tableting technique. Similarly, the prediction system will select and mix roselle extracts, banana peels extracts, vitamin B6 or vitamin B12, lotus leave extracts, fermented vegetable & fruit, tea flower (Camellia sinensis) extracts, cranberry extracts, green tea extracts and predetermined amount of carrier when the SNP sites of GNB3, SDC3, UCP3, PPARGC1B, FTO, ESR1, PPARG are abnormal. Then the personal nutrition complex in the embodiment 2 is made by a tableting technique. The following embodiments 3-7 use the same way to form a personal nutrition complex. The personal nutrition complex in the above embodiments is made to 12 tablets, and can provide a personal supplement method for more than 4 situations of gene mutation. The method also can provide a regular number of dosage for different user to prevent frequency mistake of intake.

According to the embodiments 1-7, the prediction system provides the personal nutrition complex to select volunteer for the human subject. Compared to the nutritional complex provided randomly, the present invention can effectively control generation and deposition of fat for weight maintenance.

According to the above embodiments, the present invention also can mix other nutritional supplement ingredients with high concentration and then form less than 4 tablets to reduce numbers of formulations. Present invention allows user to eat nutritional supplement complex conveniently.

What is claimed is:

1. A prediction system for an incidence of disease by genetic polymorphism comprising:
a prediction server, the prediction server collecting at least one personal information and at least one genetic information for an information exchange process and a mathematical operation, and producing a prediction report for a user subsequently;
a personal database, the personal database connected with the prediction server for receiving and storing the personal information;
a genetic risk database connected with the prediction server; the genetic risk database including multiple SNP (single nucleotide polymorphism) data and risk data that are correlated with the above genetic information;
an allelic frequency database connected with the prediction server; the allelic frequency database including a plurality of frequency data correlated with the SNP data and the risk data; and
a prevalence database connected with the prediction server; the prevalence database including a plurality of prevalence data for being provided to the server for the mathematical operation to produce the prediction report.

2. The system as claimed in claim 1, wherein the genetic risk database includes a SNP area and a risk area; the SNP area is provided to read and store the SNP data and the SNP data includes a plurality of genotypes; the risk area is used to read and store the risk data and the risk data is odds ratio.

3. The system as claimed in claim 2, wherein the frequency data is a frequency data of the allele.

4. The system as claimed in claim 3, wherein the frequency data of allele is the ratio between alleles and genotypes in a group.

5. The system as claimed in claim 4, wherein the server obtains the SNP data, the risk data and the frequency data for the information exchange process; then the system utilizes the SNP, the risk, and the frequency data to calculate multiple relative risk values before a user gets a genetic risk data based on each relative risk value.

6. The system as claimed in claim 5, wherein the system calculates the genetic risk data and the prevalence data to generate a prediction about incidence of disease.

7. The system as claimed in claim 6, wherein the SNP data includes the rs13266634 of SLC30A8 gene, the rs2237895 of KCNQ1 gene, the rs17584499 of PTPRD gene, the rs391300 of SRR gene, the rs5219 of KCNJ11 gene, the rs10946398 of CDKAL1 gene, the rs10811661 of CDKN2A/B gene, the rs7903146 of TCF7L2 gene, the rs1111875 of HHEX gene, and the rs1801282 of PPARG gene.

8. The system as claimed in claim 6, wherein the SNP data includes the rs699 of AGT gene, the rs4961 of ADD1 gene, the rs1799983 of NOS3 gene, the rs11191548 of CYP17A1 gene, the rs16998073 of FGF5 gene, the rs5186 of AGTR1 gene, the rs3865418 of NEDD4L gene, the rs3754777 of STK39 gene, and the rs3781719 of CALCA gene.

9. The system as claimed in claim 6, wherein the SNP data includes the rs1003723 of LDLR gene, the rs1367117 of APOB gene, the rs2075291 of APOA5 gene, the rs326 of LPL gene, the rs4420638 of APOE gene, the rs780094 of GCKR gene, the rs4846914 of GALNT2 gene, the rs1800588 of LIPC, the rs12654264 of HMGCR, the rs3764261 of CETP gene, and the rs17145738 of MLXIPL gene.

10. The system as claimed in claim 1, wherein the system further provides at least one user terminal that is connected with the prediction server for inputting the personal information and the genetic information; the system produces the prediction report for the user by the information exchange process and the mathematical operation and outputs the prediction report through an output terminal.

11. A method for forming personal nutrition complex according to an incidence of disease and genetic polymorphism by a prediction system comprising the steps of:
providing a biological sample taken from a subject;
testing SNP of a plurality of genes in said sample and obtaining a result;
utilizing the system of claim 1 to select nutritional supplement ingredients according to the result; and
mixing the nutritional supplement ingredients to form a personal nutrition complex.

12. The method as claimed in claim 11, wherein the plurality of genes include the gene of adipogenesis, the gene of appetite control, the gene of metabolism and the gene of endocrine regulation, and the nutritional supplement ingredients include first, second, third, and fourth nutritional supplement ingredients; when the result demonstrates abnormalities in the gene of adipogenesis, the first nutritional supplement ingredients are selected to form a personal nutrition complex; when the result demonstrates abnormalities in the gene of appetite control, the second nutritional supplement ingredients are selected to form a personal nutrition complex; when the result demonstrates abnormalities in the gene of metabolism, the third nutritional supplement ingredients are selected to form a personal nutrition complex; when the result demonstrates abnormalities in the gene of endocrine regulation, the fourth nutritional supplement ingredients are selected to form a personal nutrition complex.

13. The method as claimed in claim 12, wherein the gene of adipogenesis is peroxisome proliferator-activated receptor gamma 2 (PPARG2) or guanine nucleotide binding protein beta-subunit 3 (GNB3), and the SNP site is rs1801282 of PPARG2 and rs5443 of GNB3.

14. The method as claimed in claim 12, wherein the gene of appetite control is syndecan 3 (SDC3), leptin (LEP) or melanocortin 4 receptor (MC4R), and the SNP site is rs2282440 of SDC3, rs104894023 of LEP, and rs121913561 of MC4R.

15. The method as claimed in claim 12, wherein the gene of metabolism is uncoupling protein 3 (UCP3), beta-2-adrenergic receptor (ADRB2), peroxisome proliferator-activated receptor-gamma coactivator 1, beta (PPARGC1B), or fat mass and obesity associated gene (FTO), and the SNP site is rs17848368 of UCP3, rs1042714 of ADRB2, and rs6499640 of FTO.

16. The method as claimed in claim 12, wherein the gene of endocrine regulation is peroxisome proliferator-activated receptor-gamma (PPARG), nuclear receptor subfamily 0, group B, member 2 (NR0B2) or estrogen receptor 1 (ESR1), and the SNP site is rs1822825 of PPARG, rs74315350 of NR0B2, and rs712221 of ESR1.

17. The method as claimed in claim 11, wherein the mixing step includes mixing nutritional supplement ingredients with a carrier before forming the nutrition complex to a tablet by tableting technology.

18. The method as claimed in claim 11, wherein the personal nutrition complex is composed of multiple formulations; and the number of the multiple formulations is less than the number of genes.

19. The method as claimed in claim 11, wherein the SNP sites are the rs1801282 of PPARG2 gene, the rs5443 of GNB3 gene, the rs2282440 of SDC3 gene, the rs104894023 of LEP gene, the rs121913561 of MC4R gene, the rs17848368 of UCP3 gene, the rs1042714 of ADRB2 gene, the rs6499640 of FTO gene, the rs1822825 of PPARG gene, the rs74315350 of NR0B2 gene and the rs712221 of ESR1 gene; and the nutritional supplement ingredient is selected from bitter orange (Citrus aurantium) flavonoids, roselle extracts, and mixtures thereof; and banana peels extracts, vitamin B6, vitamin B12 and mixtures thereof; and lotus leave extracts, white kidney bean extracts, fermented vegetable and fruit, tea flower (Camellia sinensis) extracts and mixtures thereof; and cranberry extracts, green tea extracts and mixtures thereof.
